(19) United States
(12) Patent Application Publication
(10) Pub. No.: US 2016/0292506 A1
(43) Pub. Date: Oct. 6, 2016

(54) CAMERAS HAVING AN OPTICAL CHANNEL THAT INCLUDES SPATIALLY SEPARATED SENSORS FOR SENSING DIFFERENT PARTS OF THE OPTICAL SPECTRUM

(71) Applicant: Heptagon Micro Optics Pte. Ltd., Singapore (SG)

(72) Inventors: Hartmut Rudmann, Jona (CH); Kai Engelhardt, Buckenhof (DE); Yibin Tian, Mountain House, CA (US)

(73) Assignee: Heptagon Micro Optics Pte. Ltd., Singapore (SG)

(21) Appl. No.: 15/082,681

(22) Filed: Mar. 28, 2016

Related U.S. Application Data
(60) Provisional application No. 62/143,325, filed on Apr. 6, 2015.

(51) Int. Cl. G06K 9/00; H04N 5/378; G06T 7/00; H04N 5/232; G06K 9/20; H04N 5/33; H04N 9/097

(52) U.S. Cl. CPC G06K 9/00604; H04N 5/332; H04N 5/378; H04N 9/097; H04N 5/23293; G06K 9/2036; G06T 7/0057

(57) ABSTRACT

The present disclosure describes cameras having an optical channel that includes spatially separated sensors for sensing different parts of the optical spectrum. For example, in one aspect, an apparatus includes an image sensor module having an optical channel and including a multitude of spatially separated sensors to receive optical signals in the optical channel. The multitude of spatially separated sensors includes a first sensor operable to sense optical signals in a first spectral range, and a second sensor spatially separated from the first sensor and operable to sense optical signals in a second spectral range different from the first spectral range.

### CROSS-REFERENCE TO RELATED APPLICATION(S)

The present applications claims the benefit of U.S. Provisional Patent Application No. 62/143,325 filed on Apr. 6, 2015. The contents of the earlier application are incorporated herein by reference in their entirety.

### FIELD OF THE DISCLOSURE

The present disclosure relates to cameras having an optical channel that includes spatially separated sensors for sensing different parts of the optical spectrum.

### BACKGROUND

Recent developments in camera and sensor technologies, such as consumer-level photography, is the ability of sensors to record both IR and color (e.g., RGB). Various techniques can be provided for joint IR and color imaging. One approach is to swap color filters on a camera that is sensitive to IR. Taking sequential images after swapping filters, however, can present challenges when imaging moving objects. Another approach is to use one camera dedicated to IR imaging and another camera for color imaging. Using two cameras, however, can result in higher costs, larger overall footprint, and/or misalignment of the IR and color images.

### SUMMARY

The present disclosure describes cameras having an optical channel that includes spatially separated sensors for sensing different parts of the optical spectrum.

For example, in one aspect, an apparatus includes an image sensor module having an optical channel and including a multitude of spatially separated sensors to receive optical signals in the optical channel. The multitude of spatially separated sensors includes a first sensor operable to sense optical signals in a first spectral range, and a second sensor spatially separated from the first sensor and operable to sense optical signals in a second spectral range different from the first spectral range.

Some implementations include one or more of the following features. For example, in some cases, the first spectral range is in a part of the spectrum visible to humans, and the second spectral range is in an infra-red part of the spectrum. Thus, the first spectral range can be in a RGB part of the spectrum.

In some instances, an optical assembly is disposed over the spatially separated sensors, wherein the optical assembly has a circular cross-section in a plane parallel to an image plane of the image sensor module. Further, in some implementations, the first sensor is a rectangular array of pixels. The second sensor also can be a rectangular array of pixels. In some cases, a third sensor is spatially separated from the first and second sensors and is operable to sense optical signals in the second spectral range. The third sensor also can be a rectangular array of pixels. In some cases, the first sensor is larger than each of the second and third sensors (e.g., a pixel array that consumes more surface area). The second sensor can be located, for example, at one side of the first sensor, and the third sensor can be located at an opposite side of the first sensor.

In some implementations, a transparent cover is disposed between the optical assembly and the sensors, wherein the transparent cover has a first thickness directly over the first sensor and a second different thickness directly over the other sensor(s).

The image sensor module can be integrated, for example, into a host device that includes a display screen. The apparatus further can include a readout circuit, and one or more processors operable to generate an image for display on the display screen based on output signals from pixels in the first sensor when the host device is in a first orientation, and to perform iris recognition based on output signals from pixels in one of the other sensor(s) when the host device is in a second orientation.

Another aspect describes a method performed by an apparatus such as those mentioned above. The method includes receiving a user input indicative of a request to acquire image data using the image sensor module. In response to receiving the user input, an image is generated and displayed on a display screen based on output signals from pixels in the first sensor if the host device is in a first orientation. On the other hand, if the host device is in a second orientation, iris recognition of the user is performed based on output signals from pixels in the second sensor.

In some case, the method further includes displaying, on the display screen, an image based on the output signals from the pixels in the second sensor if the host device is in the second orientation. In accordance with some implementations, in the first orientation, the apparatus is oriented in a portrait format, and in the second orientation, the apparatus is oriented in a landscape format. The first sensor can be used, for example, to sense radiation in a part of the spectrum visible to humans, and the second sensor can be used, for example, to sense radiation in the infra-red part of the spectrum.

In some implementations, the apparatus further includes an eye illumination source operable to illuminate a subject's eye with IR radiation. In some instances, the eye illumination source is operable to emit modulated IR radiation, for example, toward a subject's face. The apparatus can include a depth sensor (e.g., an optical time-of-flight sensor) operable to detect optical signals indicative of distance to the subject's eye and to demodulate the detected optical signals. The one or more processors can be configured to generate depth data based on signals from the depth sensor. In some cases, the one or more processors are configured to perform eye tracking based on the depth data.

Providing spatially separated sensors for sensing different part of the optical spectrum (e.g., RGB and IR) in the same optical channel can be advantageous in some cases, because manufacturing costs can be reduced since the same optical assembly is used for signals in both parts of the spectrum. The arrangements described here also can allow areas of the image plane to be used more efficiently. In particular, areas of the image plane that otherwise would be unused can be used, e.g., for the IR sensors without increasing the overall footprint of the module. Some implementations can make it easier for a user to use a camera module in a host device for multiple applications, such as capturing and displaying a color imaging as well as for iris recognition. In some cases, a host device into which the camera module is integrated is more aesthetically pleasing because fewer holes are needed in the exterior surface of the host device.

Other aspects, features and advantages will be readily apparent from the following detailed description, the accompanying drawings, and the claims.

### BRIEF DESCRIPTION OF THE DRAWINGS

FIG. 1 illustrates an example of an image sensor module.

FIG. 2 is a top view of an image plane indicating locations of electromagnetic sensors.

FIG. 3 illustrates examples other components that can be used with the image sensor module.

FIG. 4 illustrates a host device in a vertical orientation and operable in an image display mode.

FIG. 5 illustrates the host device in a horizontal orientation and operable in an iris recognition mode.

### DETAILED DESCRIPTION

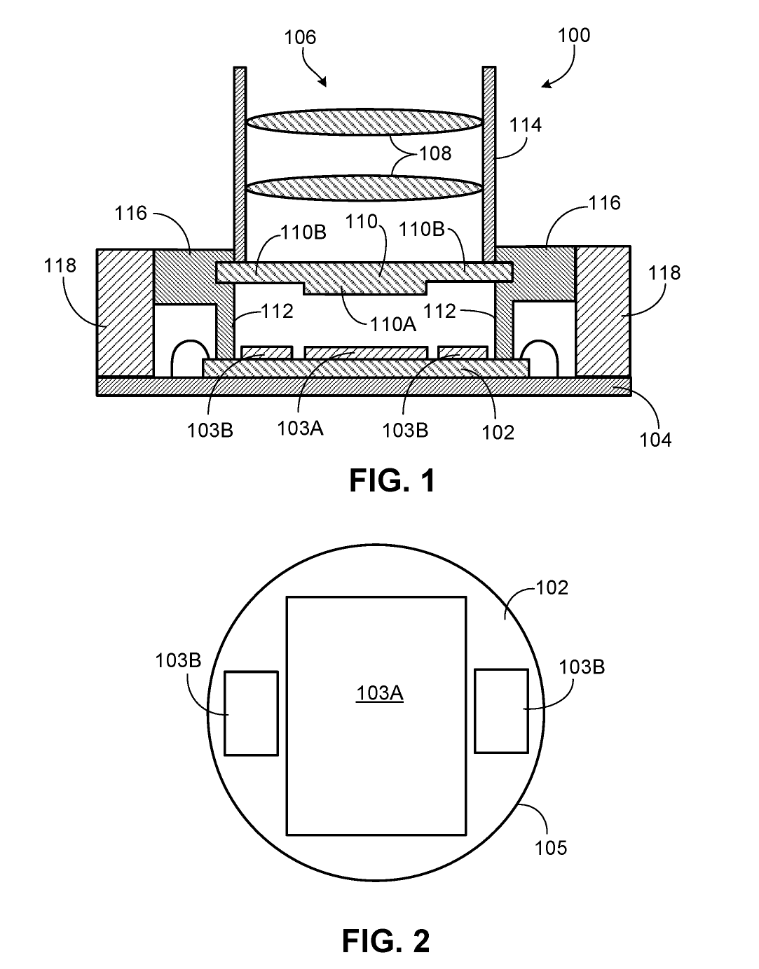

As illustrated in FIGS. 1 and 2, a packaged image sensor module 100 can provide ultra-precise and stable packaging for an image sensor 102 mounted on a substrate 104 such as a printed circuit board (PCB). An image circle 105 defines areas of the image sensor surface available, in principle, to serve as sensor areas. The sensor's image plane includes a first sensor 103A composed of an array of photosensitive elements (i.e., pixels) that are sensitive to radiation in a first part of the electromagnetic spectrum (e.g., light in the visible part of the spectrum, about 400-760 nm). The sensor's image plane also includes at least one additional sensor 103B composed of an array of pixels that are sensitive to radiation in a second part of the electromagnetic spectrum (e.g., infra-red (IR) radiation, >760 nm). In the illustrated example, the IR sensors 103B are spatially separated from the RGB sensor 103A and thus are located in regions of the image circle 105 not covered by the RGB sensor 103A.

In the illustrated example, an optical assembly, including a stack 106 of one or more optical beam shaping elements such as lenses 108, is disposed over the image sensor 102. The lenses 108 can be disposed, for example, within a circular lens barrel 114 that is supported by a transparent cover 110 (e.g., a cover glass), which in turn is supported by one or more vertical spacers 112 separating the image sensor 102 from the transparent cover 110. The vertical spacers 112 can rest directly (i.e., without adhesive) on a non-active surface of the image sensor 102. The vertical spacers 112 can thus help establish a focal length for the optical assembly 106 and/or correct for tilt.

As illustrated in the example of FIG. 1, one or more horizontal spacers 116 laterally surround the transparent cover 110 and separate the outer walls 118 of the module housing from the transparent cover 110. The outer walls 118 can be attached, for example, by adhesive to the image sensor-side of the PCB 104. Adhesive also can be provided, for example, between the side edges of the cover 110 and the housing sidewalls 118. An example of a suitable adhesive is a UV-curable epoxy.

In some cases the cover 110 is composed of glass or another inorganic material such as sapphire that is transparent to wavelengths detectable by the image sensor 102. The vertical and horizontal spacers 112, 116 can be composed, for example, of a material that is substantially opaque for the wavelength(s) of light detectable by the image sensor 102. The spacers 112, 16 can be formed, for example, by a vacuum injection technique followed by curing. Embedding the side edges of the transparent cover 110 with the opaque material of the horizontal spacers 116 can be useful in preventing stray light from impinging on the image sensor 102. The outer walls 118 can be formed, for example, by a dam and fill process.

In the illustrated example, the RGB sensor 103A is a rectangular-shaped array of 2560×1920 pixels (i.e., 5 Mpix) at or near the center of the image circle 105, whereas each IR sensor 103B is a rectangular-shaped array of 640×480 pixels closer to the periphery of the image circle. In particular, each IR sensor 103B is located adjacent a longer edge of the RGB sensor 103A, and the longer edges of the IR sensors 103B are parallel to the longer edges of the IR sensor 103A. Such an arrangement can make use of space within the image circle 105 that would remain unused if only the rectangular-shaped RGB sensor 103A were included. In some implementations, color filters are disposed over the sensor 103A to selectively allow wavelengths in the visible part of the spectrum to pass, but to block or significantly attenuate IR radiation. On the other hand, IR pass filters can be provided over the other sensors 103B.

In some implementations, the size, shape or location of the sensors may differ the foregoing example. Likewise, although the illustrated example is designed with RGB and IR sensors 103A, 103B, in other instances, the spatially separated sensors may be sensitive to other spectral ranges that differ from one another.

The sensors 103A, 103B can be implemented, for example, as CCDs or photodiodes. The RGB and IR sensors 103A, 103B can be implemented as devices formed in the same or different semiconductor or other materials. For example, in some instances, different semiconductor or other materials that maximize sensitivity to the respective wavelengths of interest can be used. Thus, a material that is particularly sensitive to radiation in the visible part of the spectrum can be used for the sensor 103A, and a different material that is particularly sensitive to IR radiation can be used for the sensors 103B. The spatially separated RGB and IR sensors 103A, 103B can be implemented, for example, in different integrated circuit chips from one another.

To provide for different focal-lengths of the lenses 108 with respect to the different sensors 103A and 103B, the thickness of the transparent cover 110 can vary across its diameter. For example, in some instances, the region 110A of the transparent cover 110 directly over the RGB sensor 103A can be thicker than the regions 110B directly over the IR sensors 103B. More generally, the thickness of the one part of the transparent cover 110 over an active area of the image sensor 102 may differ from its thickness over another active area of the image sensor, depending on the different spectral ranges the sensors are designed to detect.

Providing spatially separated sensors in the same optical channel, where the sensors are sensitive, respectively, to different spectral ranges, can be advantageous. First, using the same optical assembly for both the RGB and IR pixels can reduce the number of optical assemblies that otherwise would be needed. Further, the overall footprint of the module can be maintained relatively small since separate channels are not needed for sensing the color and IR radiation. At the same time, a given size image circle can be more used more efficiently by including multiple spatially separated sensors.

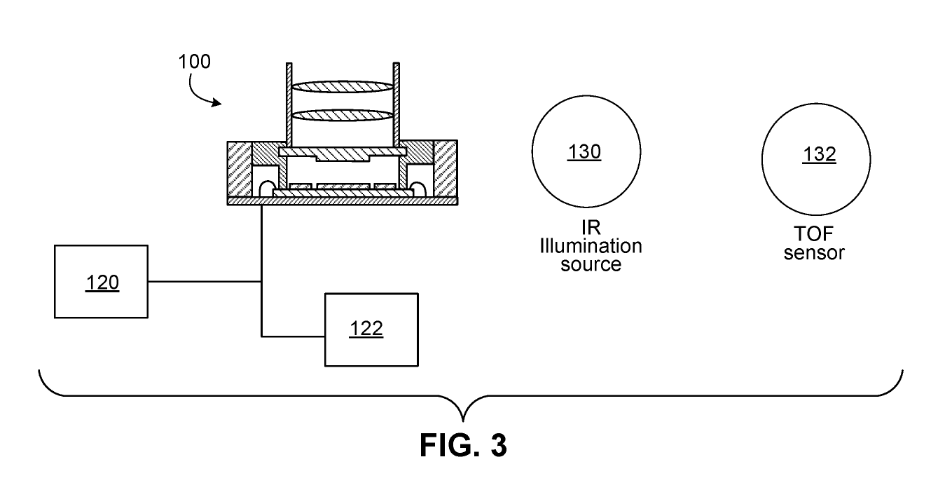

In some instances, the module 100 is operable for iris recognition or other biometric identification. Iris recognition is a process of recognizing a person by analyzing the random pattern of the iris. In such implementations, as shown in FIG. 3, an IR eye-illumination source 130, which can be integrated into the module 100 or separate from the module, is operable to emit IR radiation to the iris of a user's eye. Images of the user's iris can be captured using signals from the pixels in one of the IR sensors 103B. The acquired images can be used as input into a pattern-recognition algorithm and/or other applications executed by the processing circuit 100 or other processor in a host device. Accordingly, the complex random patterns extracted from a user's iris or irises can be analyzed, for example, to identify the user.

As further shown in FIG. 3, a read-out circuit 120 and control/processing circuit 122, such as one or more microprocessor chips, can be coupled to the sensors 103A, 103B to control reading out and processing of the signals from the pixels. Depending on the application, the processing circuit 122 can perform one or more of the following: (i) generate a color image based on output signals from the pixels in the sensor 103A for sensing radiation in the visible part of the spectrum; (ii) perform facial recognition based on output signals from the pixels in the sensor 103A; (iii) generate an IR image based on the output signals from the pixels in the sensors 103B for sensing radiation in the IR part of the spectrum; (iii) perform iris recognition based on output signals from one of the sensors 103B for sensing IR radiation.

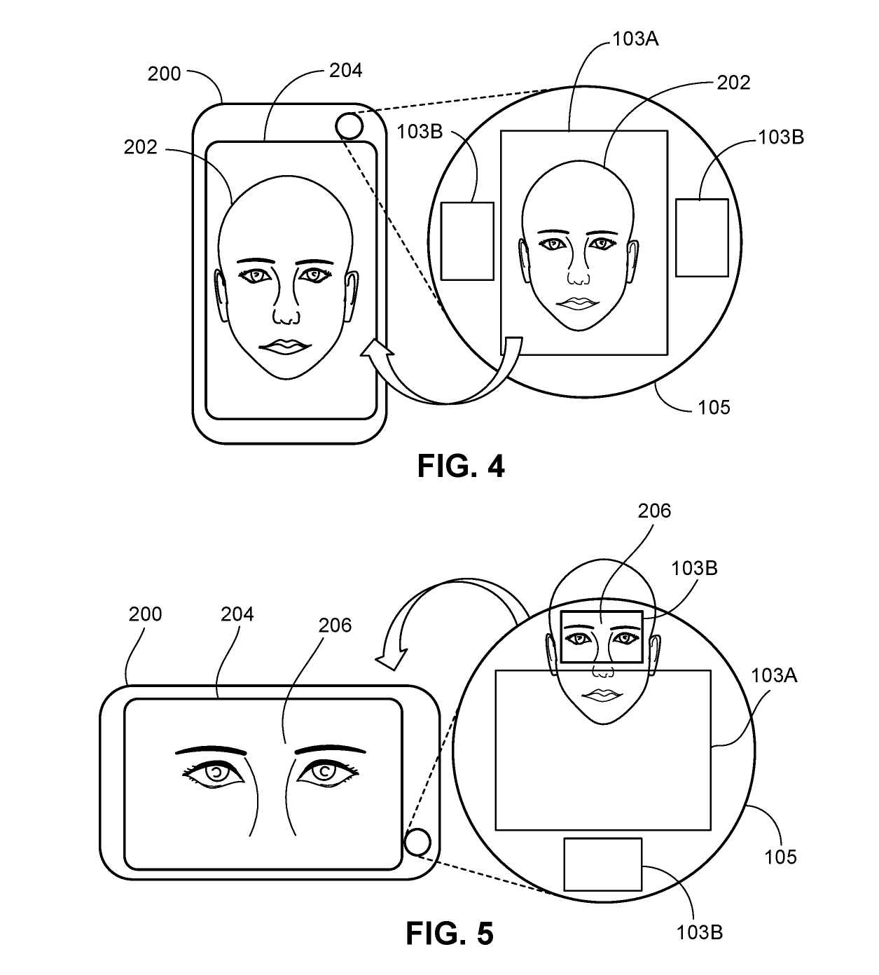

As indicated by FIGS. 4 and 5, the compact, small footprint camera modules described here can be integrated, for example, into a host device such as a smart phone 200 or other small mobile computing devices (e.g., tablets, personal data assistants (PDAs), notebook computers; laptop computers) in which the camera module is operable in both portrait format (FIG. 4) and landscape format (FIG. 5). The host device can include an accelerometer that detects the orientation of the device relative to earth and allows the device to re-orient the display screen as the user changes the device's orientation.

In some instances, when the smart phone 200 is in a vertical orientation for portrait format (FIG. 4), the camera module 100 is used in an image capture mode, whereas when the smart phone is a horizontal orientation for landscape format (FIG. 5), the camera module can be used in an iris recognition mode. Iris recognition can be advantageous to provide affirmative identification of a user and can, for example, be used to grant access of a host device to the user, and/or grant access to various applications or other software integrated into the host device (e.g., e-mail applications).

As shown in FIG. 4, when the smart phone 200 or other host device is in the vertical orientation for portrait format, and the user activates operation of the camera module 100 (e.g., by pressing a button on the host device 200), an image 202 is acquired by the RGB sensor 103A, read out by the read-out circuit 120, and processed by the processing circuit 122. The image 202 can be displayed, for example, on a display screen 204 of the host device 200.

A shown in FIG. 5, when the smart phone 200 or other host device is in the horizontal orientation for landscape format, the user can hold the smart phone 200 in front of his face such that one of the IR sensors 103B is able to acquire an image 206 of the user's eyes when the user activates operation of the camera module 100 (e.g., by pressing a button on the host device 200). The acquired IR image data can be read out by the read-out circuit 120, and processed by the processing circuit 122 in accordance with an iris recognition protocol.

In some applications, iris recognition can be performed as follows. Upon imaging an iris, a 2D Gabor wavelet filters and maps the segments of the iris into phasors (vectors). These phasors include information on the orientation and spatial frequency and the position of these areas. This information is used to map the codes, which describe the iris patterns using phase information collected in the phasors. The phase is not affected by contrast, camera gain, or illumination levels. The phase characteristic of an iris can be described, for example, using 256 bytes of data using a polar coordinate system. The description of the iris also can include control bytes that are used to exclude eyelashes, reflection(s), and other unwanted data. To perform the recognition, two codes are compared. The difference between two codes (i.e. the Hamming Distance) is used as a test of statistical independence between the two codes. If the Hamming Distance indicates that less than one-third of the bytes in the codes are different, the code fails the test of statistical significance, indicating that the codes are from the same iris. Different techniques for iris algorithm can be used in other implementations.

The IR image 202 captured by the IR sensor 103A of the image sensor 102 in the camera module 100 also can be displayed, for example, on the display screen 204 of the host device 200, which can help the user determine whether he properly positioned the camera module 100 in front of his face.

Although some implementations of the module 100 may include only a single IR sensor 103B, it can be advantageous in some cases to provide two IR sensors 103B, located near the periphery of the image circle 105 on opposite sides of the RGB sensor 103A (see FIGS. 2, 4 and 5). Such an arrangement can make it easier for a user to use the host device 200 for iris recognition because the user need not remember whether to rotate the host device clockwise or counterclockwise in order to capture an image of his eyes. For example, if the user initially holds the host device 200 in its upright vertical orientation (FIG. 4) and wants to use the host device for iris recognition, the user can rotate the host device by ninety degrees in either the clockwise or counterclockwise directions before activating the camera while it is positioned in front of his face. If the user rotates the host device by ninety degrees in the clockwise direction, then a first one of the IR sensors 103B easily can be used to acquire an image of the user's eyes, whereas if the user rotates the host device by ninety degrees in the counterclockwise direction, then the second one of the IR sensors 103B easily can be used to acquire an image of the user's eyes.

As noted above, the host device 200 or the module 100 itself can include an IR eye-illumination source 130. In some implementations, the eye illumination source 130 is operable to emit modulated IR radiation (e.g., for time-of-flight (TOF)-based configurations). In such implementations, an optical time-of-flight (TOF) sensor 132 (see FIG. 3) or other image sensor operable to detect a phase shift of IR radiation emitted by the eye illumination source can be provided either as part of the module 100 or as a separate component in the host device 200. The modulated eye illumination source can include one or more modulated light emitters such as light-emitting diodes (LEDs) or vertical-cavity surface-emitting lasers (VCSELs).

In some instances, iris recognition (based on signals from the IR sensor 103B) can be combined with other applications, such as eye tracking or gaze tracking. Eye tracking refers to the process of determining eye movement and/or gaze point and is widely used, for example, in psychology and neuroscience, medical diagnosis, marketing, product and/or user interface design, and human-computer interactions. In such implementations, the eye illumination source 130 is operable to emit homogenous IR illumination toward a subject's face (including the subject's eye), and can be modulated, for example, at a relatively high frequency (e.g., 10-100 MHz). A depth sensor such as a time-of-flight (TOF) sensor 132 detects optical signals indicative of distance to the subject's eye, demodulates the acquired signals and generates depth data. Thus, in such implementations, the TOF sensor 132 can provide depth sensing capability for eye tracking. In such implementations, operations of both the image sensor 102 and TOF sensor 132 should be synchronized with the eye illumination source 130 such that their integration timings are correlated to the timing of the eye illumination source. Further, the optical axes of the eye illumination source 130 and the image sensor 102 (which includes the IR pixels 103D) should be positioned such that there is an angle between them of no less than about five degrees. Under such conditions, the pupil of the subject's eye appears as a black circle or ellipse in the image of the eye acquired by the IR sensor 103B. It also can help reduce the impact of specular reflections from spectacles or contact lenses worn by the subject.

The module 100, as well as the illumination source 130 and depth sensor 132, can be mounted, for example, on the same or different PCBs within a host device.

Various modifications can be made within the spirit of this disclosure. Accordingly, other implementations are within the scope of the claims.

What is claimed is:

1. An apparatus comprising:
an image sensor module having an optical channel and including a plurality of spatially separated sensors to receive optical signals in the optical channel, wherein the plurality of spatially separated sensors includes:
a first sensor operable to sense optical signals in a first spectral range; and
a second sensor spatially separated from the first sensor and operable to sense optical signals in a second spectral range different from the first spectral range.

2. The apparatus of claim 1 wherein the first spectral range is in a part of the spectrum visible to humans, and the second spectral range is in an infra-red part of the spectrum.

3. The apparatus of claim 2 wherein the first spectral range is in a RGB part of the spectrum.

4. The apparatus of claim 1 further including an optical assembly disposed over the plurality of spatially separated sensors, wherein the optical assembly has a circular cross-section in a plane parallel to an image plane of the image sensor module.

5. The apparatus of claim 4 wherein the first sensor is a rectangular array of pixels.

6. The apparatus of claim 5 wherein the second sensor is a rectangular array of pixels.

7. The apparatus of claim 1 further including a third sensor spatially separated from the first and second sensors and operable to sense optical signals in the second spectral range.

8. The apparatus of claim 7 further including an optical assembly disposed over the plurality of spatially separated sensors, wherein the optical assembly has a circular cross-section in a plane parallel to an image plane of the image sensor module, and
wherein each of the first, second and third sensors is a respective rectangular array of pixels.

9. The apparatus of claim 8 wherein the first sensor is larger than each of the second and third sensors.

10. The apparatus of claim 9 wherein the second sensor is located at one side of the first sensor and the third sensor is located at an opposite side of the first sensor.

11. The apparatus of claim 10 further including a transparent cover disposed between the optical assembly and the plurality of sensors, wherein the transparent cover has a first thickness directly over the first sensor and a second different thickness directly over the second and third sensors.

12. The apparatus of claim 1 further including:
an optical assembly disposed over the plurality of spatially separated sensors; and
a transparent cover disposed between the optical assembly and the plurality of actives sensors, wherein the transparent cover has a first thickness directly over the first sensor and a second different thickness directly over the second sensor.

13. The apparatus of claim 1 including a host device having a display screen, wherein the image sensor module is integrated into the host device,
the apparatus including:
a readout circuit; and
one or more processors operable to generate an image for display on the display screen based on output signals from pixels in the first sensor when the host device is in a first orientation, and to perform iris recognition based on output signals from pixels in the second sensor when the host device is in a second orientation.

14. The apparatus of claim 7 including a host device having a display screen, wherein the image sensor module is integrated into the host device,
the apparatus including:
a readout circuit; and
one or more processors operable to generate an image for display on the display screen based on output signals from pixels in the first sensor when the host device is in a first orientation, and to perform iris recognition based on output signals from pixels in the second or third sensors when the host device is in a second orientation.

15. In an apparatus comprising a display screen, and an image sensor module having an optical channel and including a plurality of spatially separated sensors to receive optical signals in the optical channel, wherein the spatially sensors include a first sensor operable to sense optical signals in a first spectral range; and a second sensor spatially separated from the first sensor and operable to sense optical signals in a second spectral range different from the first spectral range, a method comprising:
receiving a user input indicative of a request to acquire image data using the image sensor module; and
in response to receiving the user input:
generating and displaying an image on the display screen based on output signals from pixels in the first sensor if the host device is in a first orientation, and
performing iris recognition of the user based on output signals from pixels in the second sensor if the host device is in a second orientation.

16. The method of claim 15 further including displaying, on the display screen, an image based on the output signals from the pixels in the second sensor if the host device is in the second orientation.

17. The method of claim 15 wherein in the first orientation, the apparatus is oriented in a portrait format, and in the second orientation, the apparatus is oriented in a landscape format.

18. The method of claim 15 including:
sensing, by the first sensor, radiation in a part of the spectrum visible to humans; and
sensing, by the second sensor, radiation in the infra-red part of the spectrum.

19. An apparatus comprising:
a display screen;
an image sensor module having an optical channel and including a plurality of spatially separated sensors to receive optical signals in the optical channel, wherein the spatially sensors include:
a first sensor operable to sense optical signals in a first spectral range; and
a second sensor spatially separated from the first sensor and operable to sense optical signals in a second spectral range different from the first spectral range;
the apparatus further including:
a readout circuit; and
one or more processors operable to generate an image for display on the display screen based on output signals from pixels in the first sensor when the host device is in a first orientation, and to perform iris recognition based on output signals from pixels in the second sensor when the host device is in a second orientation.

20. The apparatus of claim 19 further including an eye illumination source operable to illuminate a subject's eye with IR radiation.

21. The apparatus of claim 20 wherein the eye illumination source is operable to emit modulated IR radiation.

22. The apparatus of claim 21 wherein the eye illumination source is operable to emit the modulated IR illumination toward a subject's face;
the apparatus further including a depth sensor operable to detect optical signals indicative of distance to the subject's eye and to demodulate the detected optical signals,
wherein the one or more processors are operable to generate depth data based on signals from the depth sensor.

23. The apparatus of claim 22 wherein the depth sensor includes an optical time-of-flight sensor.

24. The apparatus of claim 22 wherein the one or more processors are operable to perform eye tracking based on the depth data.
